(19) United States
(12) Patent Application Publication
(10) Pub. No.: US 2017/0070080 A1
(43) Pub. Date: Mar. 9, 2017

(54) ELECTRONIC DEVICE AND OPERATING METHOD THEREOF

(71) Applicant: Samsung Electronics Co., Ltd., Gyeonggi-do (KR)

(72) Inventors: Daekyun KANG, Gyeonggi-do (KR); Chang-Won SON, Gyeonggi-do (KR)

(73) Assignee: Samsung Electronics Co., Ltd.

(21) Appl. No.: 15/259,779

(22) Filed: Sep. 8, 2016

(30) Foreign Application Priority Data
Sep. 8, 2015 (KR) 10-2015-0126951

(51) Int. Cl. H02J 7/02; H02J 50/12; H02J 50/80

(52) U.S. Cl. CPC H02J 7/025; H02J 7/027; H02J 50/80; H02J 50/12

(57) ABSTRACT

An electronic device and an operating method thereof are provided. The electronic device includes an antenna configured to wirelessly receive power; a wireless communication unit; and a power reception unit functionally connected to the antenna and wireless communication unit, wherein the power reception unit includes a notification processing unit, the notification processing unit being configured to transmit, via the antenna, to an external device, a communication event received from the wireless communication unit during wireless charging.

### PRIORITY

This application claims priority under 35 U.S.C. §119(a) to Korean Patent Application Ser. No. 10-2015-0126951, which was filed in the Korean Intellectual Property Office on Sep. 8, 2015, the entire content of which is incorporated herein by reference.

### BACKGROUND

1. Field of the Disclosure

The present disclosure relates generally to an electronic device and an operating method thereof, and more particularly, to an electronic device for wireless charging and an operating method thereof.

2. Description of the Related Art

In a wireless charging system, a wireless power transmission device may wirelessly transmit power, and a wireless power reception device may wirelessly receive transmitted power. In addition, the wireless power transmission device may sense an access of the wireless power reception device and then wirelessly transmit power to the wireless power reception device.

However, a user may be restricted from checking an event (e.g., a communication event and a charging state event) in a wireless power reception device while the wireless power reception device is being charged, because the user may not carry the wireless power reception device while it is being charged, and because the wireless charging efficiency will be reduced when a user temporarily carries the wireless power reception device while it is being charged. As a result, it is difficult for a user of the wireless power reception device to accurately recognize the charging state thereof.

### SUMMARY

According to an aspect of the present disclosure, an electronic device (e.g., a wireless power reception device) is provided, which wirelessly receives charging power using a wireless charging circuit and transmits notifications of events occurring in the electronic device to an external electronic device.

According to another aspect of the present disclosure, an electronic device (e.g., the wireless power transmission device) is provided, which wirelessly transmits power using a wireless charging circuit and receives and outputs various notifications of events from an external electronic device (e.g., the wireless power reception device).

In accordance with an aspect of the present disclosure, an electronic device is provided, which includes an antenna configured to wirelessly receive power; a wireless communication unit; and a power reception unit functionally connected to the antenna and wireless communication unit, wherein the power reception unit includes a notification processing unit, the notification processing unit being configured to transmit, via the antenna, a communication event received from the wireless communication unit during wireless charging.

In accordance with another aspect of the present disclosure, an operating method of an electronic device is provided, which includes wirelessly receiving power; detecting a communication event received from a wireless communication network; and transmitting notification data corresponding to the communication event to external device.

In accordance with an aspect of the present disclosure, an electronic device is provided, which includes a power transmission unit configured to wirelessly transmit power to an external device; a controller configured to detect a communication event received from the external device; and an output module configured to output alarm information corresponding to the communication event.

In accordance with an aspect of the present disclosure, an operating method of an electronic device is provided, which includes wirelessly transmitting power to an external device; detecting a communication event received from the external device; and outputting alarm information corresponding to the detected communication event.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 illustrates an electronic device in a network environment according to an embodiment of the present disclosure;

FIG. 2 is a block diagram of an electronic device according to an embodiment of the present disclosure;

FIG. 3 is a block diagram of a programming module according to an embodiment of the present disclosure;

FIG. 4 is a block diagram of a wireless charging system according to an embodiment of the present disclosure;

FIG. 5 is an exemplary diagram illustrating a wireless charging system according to an embodiment of the present disclosure of the present disclosure;

FIG. 6 illustrates a signal flow in a wireless charging system according to an embodiment of the present disclosure;

FIG. 7A, FIG. 7B, FIG. 7C, and FIG. 7D are diagrams illustrating an operating method in a wireless charging system according to an embodiment of the present disclosure;

FIG. 8 is a block diagram of a wireless power reception device according to an embodiment of the present disclosure;

FIG. 9 illustrates a flow chart of an operating method of a wireless power reception device according to an embodiment of the present disclosure;

FIG. 10A, FIG. 10B, FIG. 10C, and FIG. 10D are exemplary diagrams illustrating an operating method of a wireless power reception device according to an embodiment of the present disclosure;

FIG. 11 is a block diagram of a wireless power transmission device according to an embodiment of the present disclosure;

FIG. 12 illustrates a signal flow in a wireless power transmission device according to an embodiment of the present disclosure;

FIG. 13 illustrates a flow chart of an operating method of a wireless power transmission device according to an embodiment of the present disclosure;

FIG. 14 illustrates a flow chart of an operating method of a wireless power transmission device according to an embodiment of the present disclosure; and

FIG. 15A, FIG. 15B, FIG. 15C, and FIG. 15D are exemplary diagrams illustrating an operating method of a wireless power transmission device according to an embodiment of the present disclosure.

### DETAILED DESCRIPTION

Hereinafter, various embodiments of the present disclosure will be described with reference to the accompanying drawings. The embodiments and the terms used therein do not limit the technology disclosed herein to specific forms, and should be understood to include various modifications, equivalents, and/or alternatives to the corresponding embodiments.

In the description of the drawings, similar reference numerals may be used to designate similar elements.

Herein, singular forms may include plural forms as well unless the context clearly indicates otherwise. The expressions “A or B”, “at least one of A and/or B”, and “A/B” may include all possible combinations of the items listed.

The expressions “a first”, “a second”, “the first”, and “the second” may modify corresponding elements regardless of the order or importance, and is used only to distinguish one element from another element, but do not limit the corresponding elements.

When an element (e.g., a first element) is referred to as being “(functionally or communicatively) connected,” or “coupled” to another element (e.g., a second element), the first element may be directly connected to the second element or indirectly connected to the other element through another element (e.g., a third element).

Herein, the expression “configured to” may be used interchangeably with “suitable for”, “having the capacity to”, “designed to”, “adapted to”, “made to”, or “capable of” in terms of hardware or software, according to circumstances. Alternatively, in some situations, the expression “device configured to” may mean that the device, together with other devices or components, “is able to”. For example, the phrase “processor adapted (or configured) to perform A, B, and C” may mean a dedicated processor (e.g., an embedded processor) only for performing the corresponding operations or a general-purpose processor (e.g., a central processing unit (CPU) or an application processor (AP)) that can perform the corresponding operations by executing one or more software programs stored in a memory device.

An electronic device according to an embodiment of the present disclosure may include a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device. For example, the wearable device may include an accessory type wearable device (e.g., a watch, a ring, a bracelet, an anklet, a necklace, eyeglasses, contact lens, or a head-mounted device (HMD)), a fabric or clothing integrated type wearable device (e.g., an electronic clothing), a body-mounted type (e.g., a skin pad, or tattoo), and a bio-implantable type wearable device (e.g., an implantable circuit).

The electronic device may also include a television (TV), a digital video disk (DVD) player, an audio player, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

The electronic device may also include various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic device for a ship (e.g., a navigation device for a ship, and a gyro-compass), avionics, security devices, an automotive head unit, a robot for home or industry, an automatic teller machine (ATM), point of sales (POS) terminal, or Internet of Things (IoT) device (e.g., a light bulb, various sensors, electric or gas meter, a sprinkler device, a fire alarm, a thermostat, a streetlamp, a toaster, sporting goods, a hot water tank, a heater, a boiler, etc.).

The electronic device may also include a part of furniture or a building/structure, an electronic board, an electronic signature receiving device, a projector, and various types of measuring instruments (e.g., a water meter, an electric meter, a gas meter, a radio wave meter, etc.).

The electronic device may also be flexible, or may be a combination of one or more of the aforementioned various devices.

The electronic device is not limited to the above described devices.

Herein, the term “user” may indicate a person using an electronic device or a device (e.g., an artificial intelligence electronic device) using an electronic device.

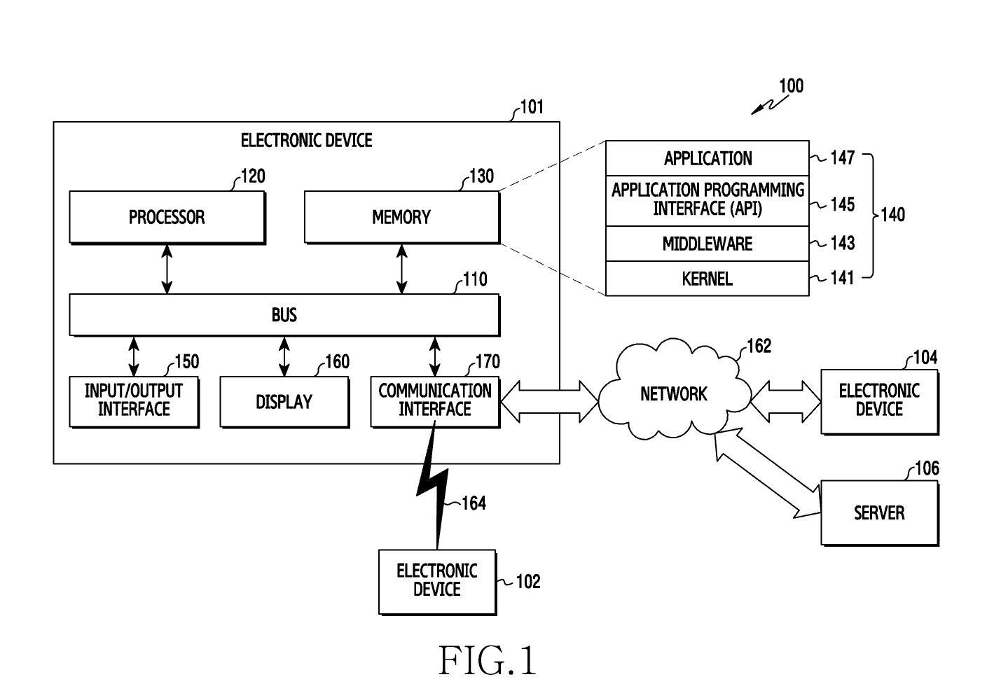

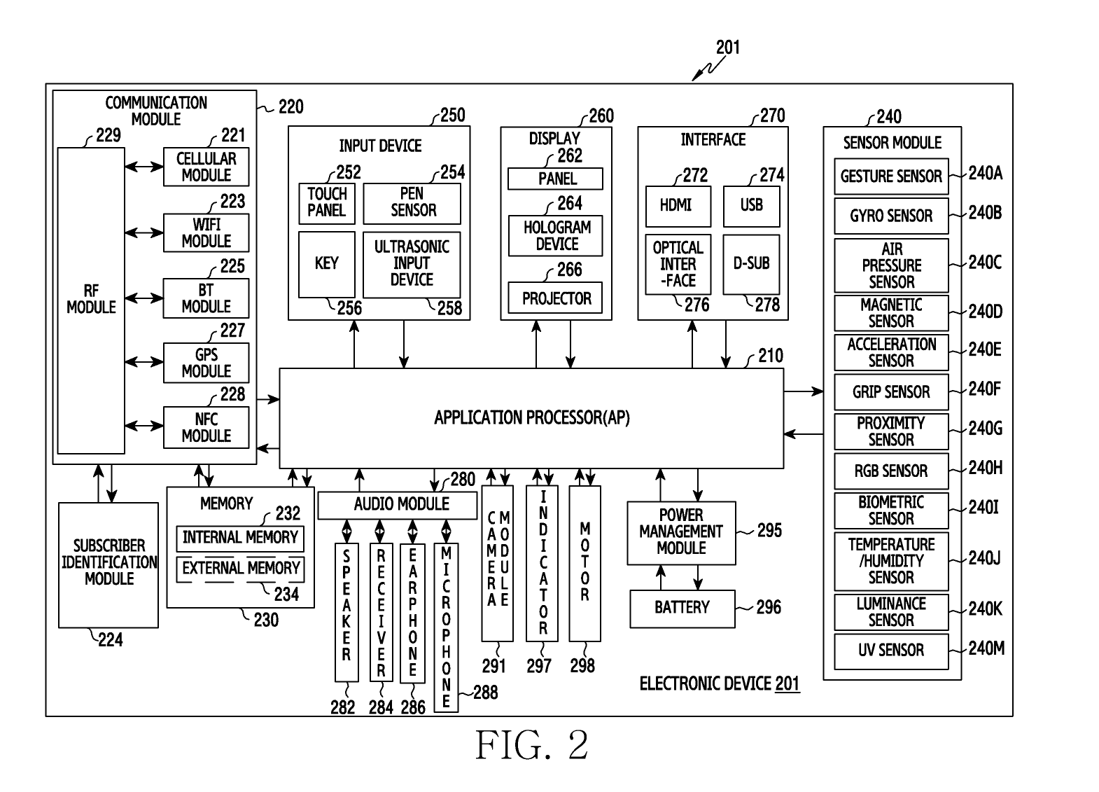

FIG. 1 illustrates an electronic device in a network environment according to an embodiment of the present disclosure.

Referring to FIG. 1, the electronic device 101 includes a bus 110, a processor 120, a memory 130, an input/output interface 150, a display 160, and a communication circuit 170. The electronic device 101 may omit at least one of the elements, or may further include other elements. The bus 110 may include a circuit that interconnects the elements 110 to 170 and transfers communication (e.g., control messages and/or data) between the elements. The processor 120 may include one or more of a central processing unit, an application processor, and a communication processor (CP). For example, the processor 120 may carry out operations or data processing relating to the control and/or communication of at least one other element of the electronic device 101.

The memory 130 may include a volatile memory and/or a non-volatile memory. The memory 130 may store, for example, instructions or data relating to at least one other element of the electronic device 101. The memory 130 may store software and/or a program 140. The program 140 includes, for example, a kernel 141, middleware 143, an application programming interface (API) 145, and/or application programs (or “applications”) 147. At least a part of the kernel 141, the middleware 143, or the API 145 may be referred to as an operating system (OS). For example, the kernel 141 may control or manage system resources (e.g., the bus 110, the processor 120, the memory 130, etc.) that are used to execute operations or functions implemented in the other programs (e.g., the middleware 143, the API 145, and the application programs 147). Further, the kernel 141 may provide an interface through which the middleware 143, the API 145, or the application programs 147 may access the individual elements of the electronic device 101 to control or manage the system resources.

The middleware 143 may function, for example, as an intermediary for allowing the API 145 or the application programs 147 to communicate with the kernel 141 to exchange data. In addition, the middleware 143 may process one or more task requests received from the application programs 147 according to priorities thereof. For example, the middleware 143 may assign priorities for using the system resources (e.g., the bus 110, the processor 120, the memory 130, etc.) of the electronic device 101 to one or more of the application programs 147, and may process the one or more task requests.

The API 145 is an interface used by the applications 147 to control a function provided from the kernel 141 or the middleware 143, and may include, for example, at least one interface or function (e.g., an instruction) for file control, window control, image processing, text control, etc. For example, the input/output interface 150 may forward instructions or data, which is input from a user or an external device, to the other element(s) of the electronic device 101, or may output instructions or data, which is received from the other element(s) of the electronic device 101, to the user or the external device.

The display 160 may include a liquid crystal display (LCD), a light emitting diode (LED) display, an organic light emitting diode (OLED) display, a micro electro mechanical system (MEMS) display, or an electronic paper display. The display 160 may display, for example, various types of content (e.g., text, images, videos, icons, and/or symbols) for a user. The display 160 may include a touch screen and may receive, for example, a touch input, a gesture input, a proximity input, or a hovering input using an electronic pen or a user's body part.

The communication interface 170 may configure, for example, communication between the electronic device 101 and an external device (e.g., a first external electronic device 102, a second external electronic device 104, or a server 106). For example, the communication interface 170 may be connected to a network 162 through wireless or wired communication to communicate with the external device (e.g., the second external device 104 or the server 106).

The wireless communication may include, for example, a cellular communication that uses at least one of LTE, LTE-Advance (LTE-A), code division multiple access (CDMA), wideband CDMA (WCDMA), universal mobile telecommunications system (UMTS), wireless broadband (WiBro), global system for mobile communications (GSM), etc. The wireless communication may include, for example, at least one of WiFi, Bluetooth, Bluetooth low energy (BLE), Zigbee, near field communication (NFC), magnetic secure transmission, radio frequency, and body area network (BAN). The wired communication may include GNSS. The GNSS may be, for example, a global positioning system (GPS), a global navigation satellite system (Glonass), a Beidou navigation satellite system (hereinafter, referred to as “Beidou”), or Galileo (the European global satellite-based navigation system). Hereinafter, the term “GPS” may be interchangeably used with the term “GNSS” in the present disclosure. The wired communication may include, for example, at least one of a universal serial bus (USB), a high definition multimedia interface (HDMI), recommended standard 232 (RS-232), and a plain old telephone service (POTS).

The network 162 may include a telecommunications network, which may be, for example, at least one of a computer network (e.g., a LAN or a WAN), the Internet, and a telephone network.

The first and second external electronic devices 102 and 104 may be the same type as, or a different type than, the electronic device 101.

All or some of the operations performed in the electronic device 101 may be performed in another electronic device or in a plurality of electronic devices (e.g., the electronic devices 102 and 104 or the server 106). In a case where the electronic device 101 has to perform some functions or services automatically or in response to a request, the electronic device 101 may request another device (e.g., the electronic device 102 or 104 or the server 106) to perform at least some functions relating thereto instead of, or in addition to, performing the functions or services by itself. The other electronic device (e.g., the electronic device 102 or 104, or the server 106) may execute the requested functions or the additional functions and may deliver the execution result to the electronic device 101. The electronic device 101 may process the received result as it is or additionally to provide the requested functions or services. To achieve this, for example, cloud computing, distributed computing, or client-server computing technology may be used.

FIG. 2 is a block diagram of an electronic device 201 according to an embodiment of the present disclosure.

Referring to FIG. 2, the electronic device 201 includes at least one processor 210 (e.g., an AP), a communication module 220, a subscriber identification module 224, a memory 230, a sensor module 240, an input device 250, a display 260, an interface 270, an audio module 280, a camera module 291, a power management module 295, a battery 296, an indicator 297, and a motor 298. The processor 210 may, for example, control a plurality of hardware or software elements connected thereto and perform various types of data processing and operations by driving an operating system or an application program. The processor 210 may be implemented as, for example, a system on chip (SoC). According to an embodiment, the processor 210 may further include a graphic processing unit (GPU) and/or an image signal processor. The processor 210 may include at least some (e.g., a cellular module 221) of the elements illustrated in FIG. 2. The processor 210 may load, in a volatile memory, instructions or data received from at least one of the other elements (e.g., a non-volatile memory), process the loaded instructions or data, and store the result data in the non-volatile memory.

The communication module 220 includes a cellular module 221, a WiFi module 223, a Bluetooth module 225, a GNSS module 227, an NFC module 228, and an RF module 229.

The cellular module 221 may provide, for example, a voice call, a video call, a text message service, an Internet access service, etc. through a communication network. The cellular module 221 may identify and authenticate the electronic device 201 within a communication network using the subscriber identification module 224 (e.g., a SIM card). The cellular module 221 may perform at least some of the functions that the processor 210 may provide. The cellular module 221 may include a communication processor (CP). At least some (two or more) of the cellular module 221, the WiFi module 223, the Bluetooth module 225, the GNSS module 227, and the NFC module 228 may be included in one integrated chip (IC) or IC package.

The RF module 229 may transmit/receive, for example, a communication signal (e.g., an RF signal). The RF module 229 may include, for example, a transceiver, a power amp module (PAM), a frequency filter, a low noise amplifier (LNA), an antenna, etc.

At least one of the cellular module 221, the WiFi module 223, the Bluetooth module 225, the GNSS module 227, and the NFC module 228 may transmit/receive an RF signal through a separate RF module.

The subscriber identification module 224 may include, for example, a card that includes an embedded SIM, and may contain unique identification information (e.g., an integrated circuit card identifier (ICCID)) or subscriber information (e.g., international mobile subscriber identity (IMSI)).

The memory 230 includes an internal memory 232 or an external memory 234. The internal memory 232 may include, for example, at least one of a volatile memory (e.g., a DRAM, an SRAM, an SDRAM, etc.) and a non-volatile memory (e.g., a one time programmable ROM (OTPROM), a PROM, an EPROM, an EEPROM, a mask ROM, a flash ROM, a flash memory, a hard disc drive, or a solid state drive (SSD)). The external memory 234 may include a flash drive, for example, a compact flash (CF), a secure digital (SD), a micro-SD, a mini-SD, an eXtreme digital (xD), a multi-media card (MMC), a memory stick, etc. The external memory 234 may be functionally or physically connected to the electronic device 201 through various interfaces.

The sensor module 240 may, for example, measure a physical quantity or detect the operating state of the electronic device 201 and may convert the measured or detected information into an electrical signal. The sensor module 240 includes a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green, blue (RGB) sensor), a biometric sensor 2401, a temperature/humidity sensor 240J, an illumination sensor 240K, and a ultraviolet (UV) sensor 240M. Additionally or alternatively, the sensor module 240 may include, for example, an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. The electronic device 201 may further include a processor configured to control the sensor module 240 as a part of, or separately from, the processor 210 and may control the sensor module 240 while the processor 210 is in a sleep state.

The input device 250 includes a touch panel 252, a (digital) pen sensor 254, a key 256, or an ultrasonic input device 258. The touch panel 252 may use, for example, at least one of a capacitive type, a resistive type, an infrared type, and an ultrasonic type. Further, the touch panel 252 may further include a control circuit. The touch panel 252 may further include a tactile layer to provide a tactile reaction to a user. The (digital) pen sensor 254 may include, for example, a recognition sheet that is a part of, or separate from, the touch panel. The key 256 may include, for example, a physical button, an optical key, or a keypad. The ultrasonic input device 258 may detect ultrasonic waves, which are generated by an input tool, through a microphone (e.g., a microphone 288) to identify data that correspond to the detected ultrasonic waves.

The display 260 includes a panel 262, a hologram device 264, a projector 266, and/or a control circuit for controlling them. The panel 262 may be implemented to be, for example, flexible, transparent, or wearable. The panel 262, together with the touch panel 252, may be configured as one or more modules. The hologram device 264 may show a three-dimensional image in the air using an interference of light. The projector 266 may display an image by projecting light onto a screen. The screen may be located, for example, inside or outside the electronic device 201.

The interface 270 includes an HDMI 272, a USB 274, an optical interface 276, or a D-subminiature (D-sub) 278. Additionally or alternatively, the interface 270 may include, for example, a mobile high-definition link (MHL) interface, an SD card/multi-media card (MMC) interface, or an infrared data association (IrDA) standard interface.

The audio module 280, for example, may convert a sound into an electrical signal, and vice versa. The audio module 280 may process sound information that is input or output through, for example, a speaker 282, a receiver 284, earphones 286, the microphone 288, etc.

The camera module 291 is a device that can photograph a still image and a moving image. According to an embodiment of the present disclosure, the camera module 291 may include one or more image sensors (e.g., a front sensor or a rear sensor), a lens, an image signal processor (ISP), or a flash (e.g., an LED or xenon lamp).

The power management module 295 may manage, for example, the power of the electronic device 201. The power management module 295 may include a power management integrated circuit (PMIC), a charger IC, or a battery gauge. The PMIC may have a wired and/or wireless charging scheme. Examples of the wireless charging scheme may include a magnetic resonance method, a magnetic induction method, an electromagnetic wave method, etc. Additional circuits (e.g., a coil loop, a resonance circuit, a rectifier, etc.) for wireless charging may be further included. The battery gauge may measure, for example, the residual charge quantity of the battery 296 and a voltage, current, or temperature while charging.

The battery 296 may include, for example, a rechargeable battery and/or a solar battery.

The indicator 297 may display a particular state (e.g., a booting state, a message state, a charging state, etc.) of the electronic device 201 or a part thereof (e.g., the processor 210).

The motor 298 may convert an electrical signal into a mechanical vibration and may generate a vibration, a haptic effect, etc.

The electronic device 201 may include a mobile TV support device that can process media data according to a standard, such as digital multimedia broadcasting (DMB), digital video broadcasting (DVB), mediaFlo™, etc.

Each of the above-described component elements of hardware according to an embodiment of the present disclosure may be configured with one or more components, and the names of the corresponding component elements may vary based on the type of electronic device. In various embodiments of the present disclosure, an electronic device (e.g., the electronic device 201) may omit some elements or may further include additional elements, or some of the elements of the electronic device may be combined with each other to configure one entity, in which case the electronic device may identically perform the functions of the corresponding elements prior to the combination.

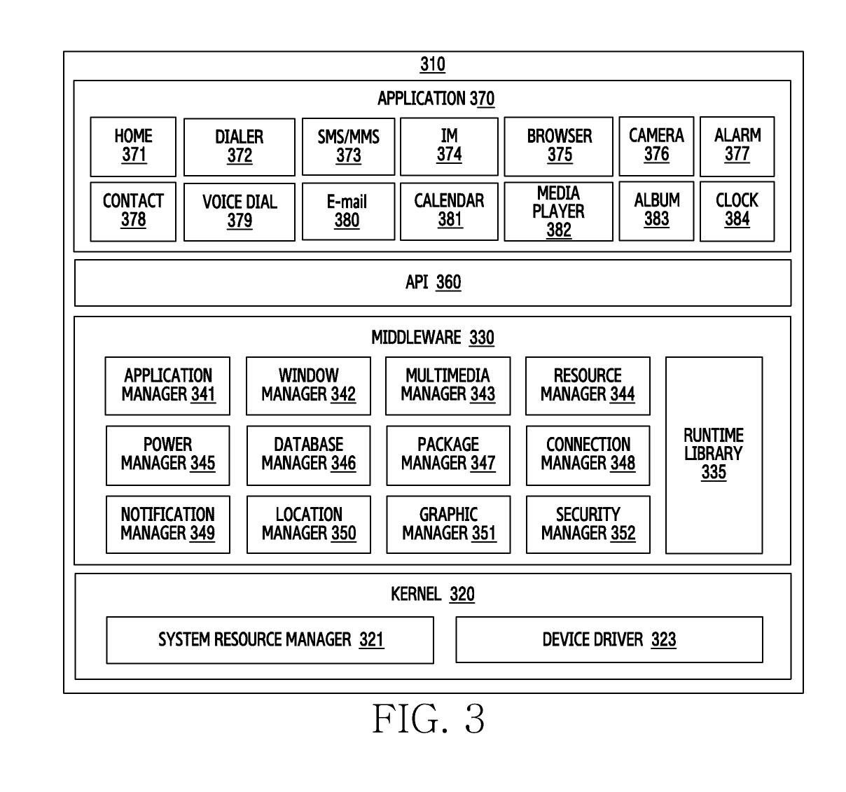

FIG. 3 is a block diagram of a program module according to an embodiment of the present disclosure.

The program module 310 (e.g., the program 140) may include an operating system (OS) that controls resources relating to an electronic device (e.g., the electronic device 101) and/or various applications (e.g., the application programs 147) that are driven on the operating system. The operating system may include, for example, Android™, iOS™, Windows™, Symbian™, Tizen™, or Bada™. Referring to FIG. 3, the program module 310 includes a kernel 320 (e.g., the kernel 141), middleware 330 (e.g., the middleware 143), an API 360 (e.g., the API 145), and/or applications 370 (e.g., the application programs 147). At least a part of the program module 310 may be preloaded on the electronic device, or may be downloaded from an external electronic device (e.g., the electronic device 102 or 104 or the server 106).

The kernel 320 includes, for example, a system resource manager 321 and/or a device driver 323. The system resource manager 321 may control, allocate, or retrieve system resources. According to an embodiment of the present disclosure, the system resource manager 321 may include a process manager, a memory manager, or a file system manager. The device driver 323 may include, for example, a display driver, a camera driver, a Bluetooth driver, a shared memory driver, a USB driver, a keypad driver, a WiFi driver, an audio driver, or an inter-process communication (IPC) driver. For example, the middleware 330 may provide a function required by the applications 370 in common, or may provide various functions to the applications 370 through the API 360 to enable the applications 370 to use the limited system resources within the electronic device.

The middleware 330 includes at least one of a runtime library 335, an application manager 341, a window manager 342, a multi-media manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module used by a compiler in order to add a new function through a programming language while the applications 370 are being executed. The runtime library 335 may manage an input/output, manage a memory, or process an arithmetic function.

The application manager 341 may manage, for example, the life cycles of the applications 370.

The window manager 342 may manage GUI resources used for a screen. The multimedia manager 343 may identify formats required for reproducing various media files and may encode or decode a media file using a codec suitable for the corresponding format.

The resource manager 344 may manage the source codes of the applications 370 or the space of a memory.

The power manager 345 may manage, for example, the capacity or power of a battery and may provide power information required for operating the electronic device. The power manager 345 may operate in conjunction with a basic input/output system (BIOS).

The database manager 346 may, for example, generate, search, or change databases to be used by the applications 370.

The package manager 347 may manage the installation or update of an application that is distributed in the form of a package file.

The connectivity manager 348 may manage, for example, a wireless connection.

The notification manager 349 may provide an event (e.g., an arrival message, an appointment, a proximity notification, etc.) to a user.

The location manager 350 may manage, for example, the location information of the electronic device.

The graphic manager 351 may manage, for example, a graphic effect to be provided to a user, or a user interface relating thereto.

The security manage 352 may provide, for example, system security or user authentication.

The middleware 330 may include a telephony manager for managing a voice or video call function of the electronic device or a middleware module that is capable of forming a combination of the functions of the above-described elements. The middleware 330 may provide specialized modules according to the types of operation systems. The middleware 330 may dynamically remove some of the existing elements, or may add new elements.

The API 360 is, for example, a set of API programming functions, and may be provided with different configurations according to operating systems. For example, in the case of Android or iOS, each platform may be provided with one API set, and in the case of Tizen, each platform may be provided with two or more API sets.

The applications 370 include a home application 371, a dialer application 372, an SMS/MMS application 373, an instant message (IM) application 374, a browser application 375, a camera application 376, an alarm application 377, a contacts application 378, a voice dial application 379, an e-mail application 380, a calendar application 381, a media player application 382, an album application 383, a watch application 384, a health care application (e.g., an application for measuring exercise quantity or blood glucose level), an application providing environment information (e.g., atmospheric pressure, humidity, or temperature information), etc. The applications 370 may also include an information exchange application that can support the exchange of information between the electronic device and an external electronic device. The information exchange application may include, for example, a notification relay application for relaying particular information to an external electronic device or a device management application for managing an external electronic device. For example, the notification relay application may relay notification information generated in the other applications of the electronic device to an external electronic device, or may receive notification information from an external electronic device to provide the received notification information to a user. The device management application may install, delete, or update functions of an external electronic device that communicates with the electronic device (e.g., turning on/off the external electronic device itself (or some elements thereof) or adjusting the brightness (or resolution) of a display) or applications executed in the external electronic device.

The applications 370 may include applications (e.g., a health care application of a mobile medical appliance) that are designated according to the attributes of an external electronic device. The applications 370 may include applications received from an external electronic device. At least some of the program module 310 may be implemented in software, firmware, hardware (e.g., the processor 210), or a combination of two or more thereof. At least some of the program module 310 may include, for example, a module, a program, a routine, a set of instructions, and/or a process for performing one or more functions.

Herein, the term “module” includes a unit that includes hardware, software, or firmware and may be used interchangeably with the terms “logic”, “logical block, or “circuit. A “module” may be an integrated part, or a minimum unit for performing one or more functions or a part thereof. A “module” may be mechanically or electronically implemented and may include, for example, an application-specific integrated circuit (ASIC) chip, a field-programmable gate arrays (FPGA), or a programmable-logic device, which are known or are to be developed in the future, for performing certain operations.

At least some of devices (e.g., modules or functions thereof) or methods (e.g., operations) may be implemented by an instruction which is stored a non-transitory computer-readable storage medium (e.g., the memory 130) in the form of a program module. The instruction, when executed by a processor (e.g., the processor 120), may cause the one or more processors to execute the function corresponding to the instruction. The non-transitory computer-readable storage medium may include a hard disk, a floppy disk, a magnetic medium (e.g., a magnetic tape), an optical media (e.g., CD-ROM, DVD), a magneto-optical media (e.g., a floptical disk), an inner memory, etc. The instruction may include a code which is made by a compiler or a code which may be executed by an interpreter. The programming module according to an embodiment of the present disclosure may include one or more of the aforementioned components or may further include other additional components, or some of the aforementioned components may be omitted. Operations performed by a module, a programming module, or other elements according to various embodiments of the present disclosure may be executed sequentially, in parallel, repeatedly, or in a heuristic manner. At least some operations may be executed according to another sequence, may be omitted, or may further include other operations.

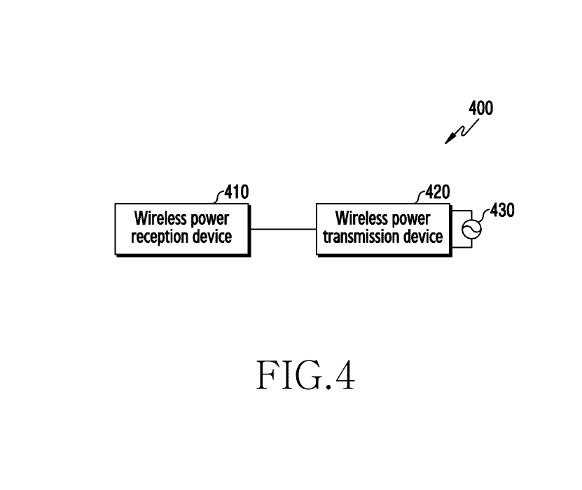

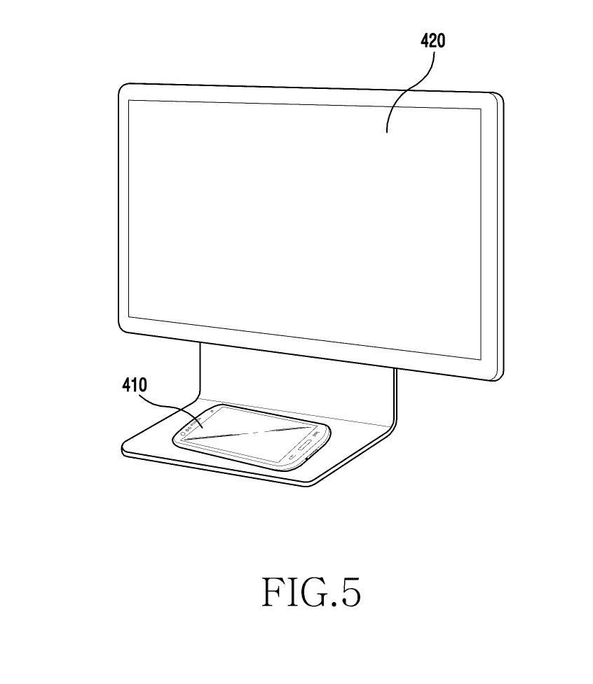

FIG. 4 is a block diagram of a wireless charging system according to an embodiment of the present disclosure. FIG. 5 is an exemplary diagram illustrating a wireless charging system according to an embodiment of the present disclosure.

Referring to FIG. 4, a wireless charging system 400 includes a wireless power reception device 410 and a wireless power transmission device 420. The wireless power reception device 410 and wireless power transmission device 420 may be one electronic device, respectively, and may be external devices with respect to each other.

The wireless power reception device 410 may wirelessly receive power. The wireless power reception device 410 and the wireless power transmission device 420 may receive AC power. In addition, the wireless power reception device 410 may convert AC power to DC power. The wireless power reception device 410 may receive power using a wireless power protocol. The wireless power reception device 410 may receive power according to a specified receiving scheme. For example, a receiving scheme may include an electromagnetic induction scheme, a resonance scheme and a RF/micro wave radiation scheme. Accordingly, the wireless power reception device 410 may be driven using power. In addition, the wireless power reception device 410 may generate and transmit notification data. The wireless power reception device 410 may transmit the notification data using a wireless power protocol. The notification data may include at least one of communication information or charging state information.

The wireless power transmission device 420 may wirelessly transmit power. To this end, the wireless power transmission device 420 may be connected to the power source 430 and receive power from the power source 430. The wireless power transmission device 420 may transmit AC power. The wireless power transmission device 420 may receive power using a wireless power protocol. The wireless power transmission device 420 may transmit power according to at least one specified transmission scheme. For example, a transmission scheme may include an electromagnetic induction scheme, a resonance scheme, and a RF/micro wave radiation scheme. In addition, the wireless power transmission device 420 may receive and output notification data. The wireless power transmission device 420 may receive notification data using a wireless power protocol.

In order to receive power from the wireless power transmission device 420 by the wireless power reception device 410, the receiving scheme of the wireless power reception device 410 may need to match the transmission scheme of the wireless power transmission device 420. For example, when the receiving scheme of the wireless power reception device 410 and the transmission scheme of the wireless power transmission device 420 both match the electromagnetic induction scheme, the wireless power transmission device 420 may transmit power using the electromagnetic induction scheme, and the wireless power reception device 410 may receive power using the electromagnetic induction scheme.

However, when the receiving scheme of the wireless power reception device 410 and the transmission scheme of the wireless power transmission device 420 both match the resonance scheme, the wireless power transmission device 420 may transmit power using the resonance scheme, and the wireless power reception device 410 may receive power using the resonance scheme.

However, when the receiving scheme of the wireless power reception device 410 and the transmission scheme of the wireless power transmission device 420 both match the RF scheme, the wireless power transmission device 420 may transmit power using the RF scheme, and the wireless power reception device 410 may receive power using the RF scheme.

In addition, in order to receive power from the wireless power transmission device 420 by the wireless power reception device 410, the wireless power reception device 410 may be disposed to correspond to the wireless power transmission device 420. According to various embodiments of the present disclosure, the wireless power reception device 410 may be disposed adjacent to the wireless power transmission device 420. Accordingly, the wireless power transmission device 420 may include a specified charge zone. In addition, if the wireless power reception device 410 is disposed in the charge zone, the wireless power transmission device 420 may detect the wireless power reception device 410. For example, as illustrated in FIG. 5, the wireless power reception device 410 may be disposed so as to correspond to the wireless power transmission device 420.

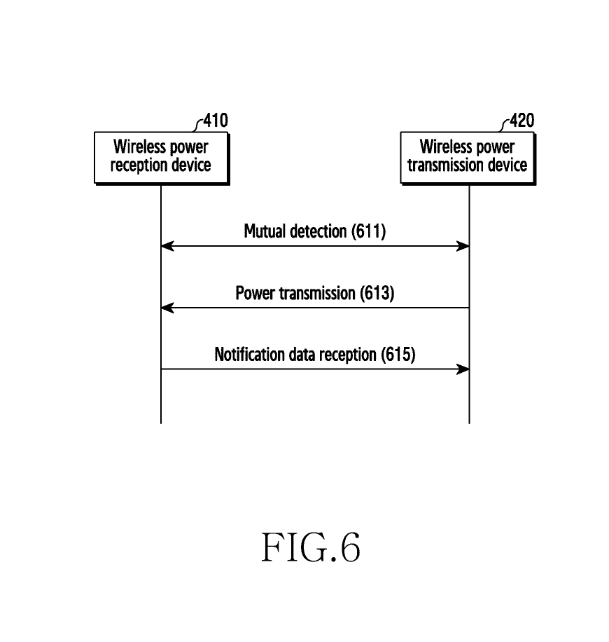

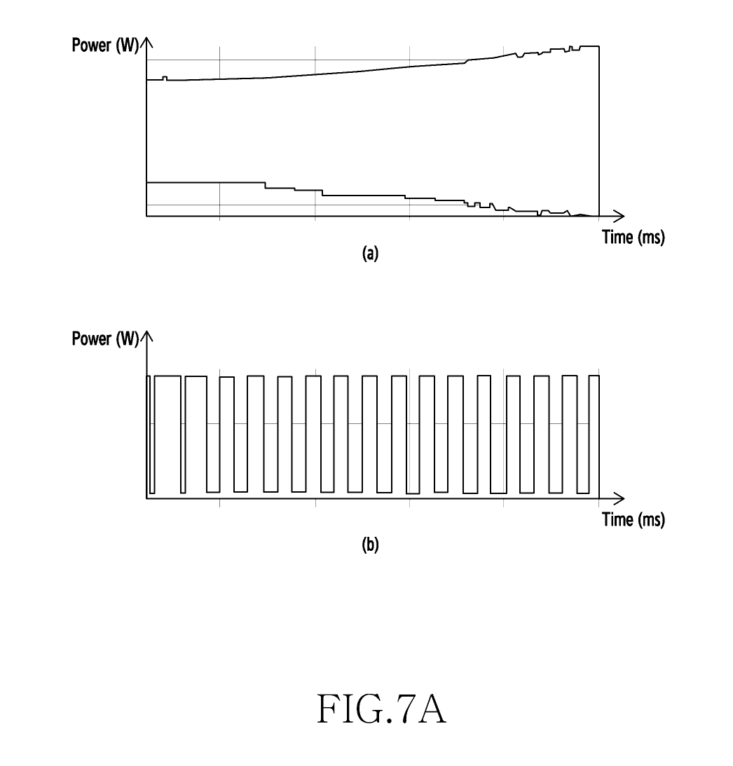

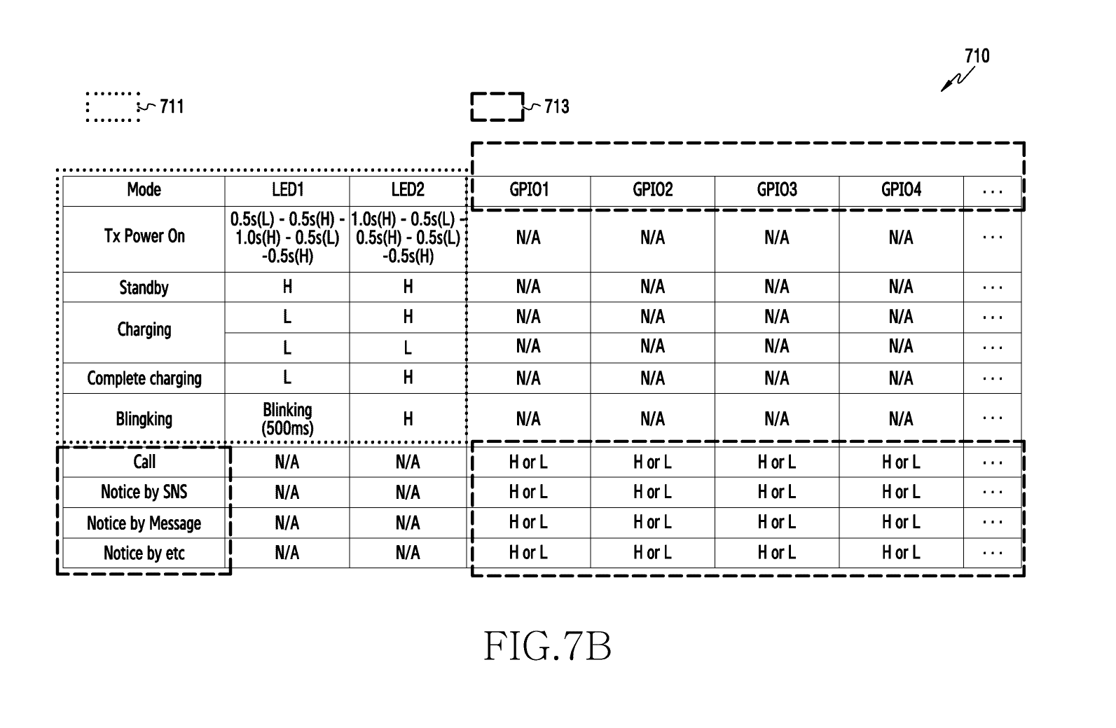

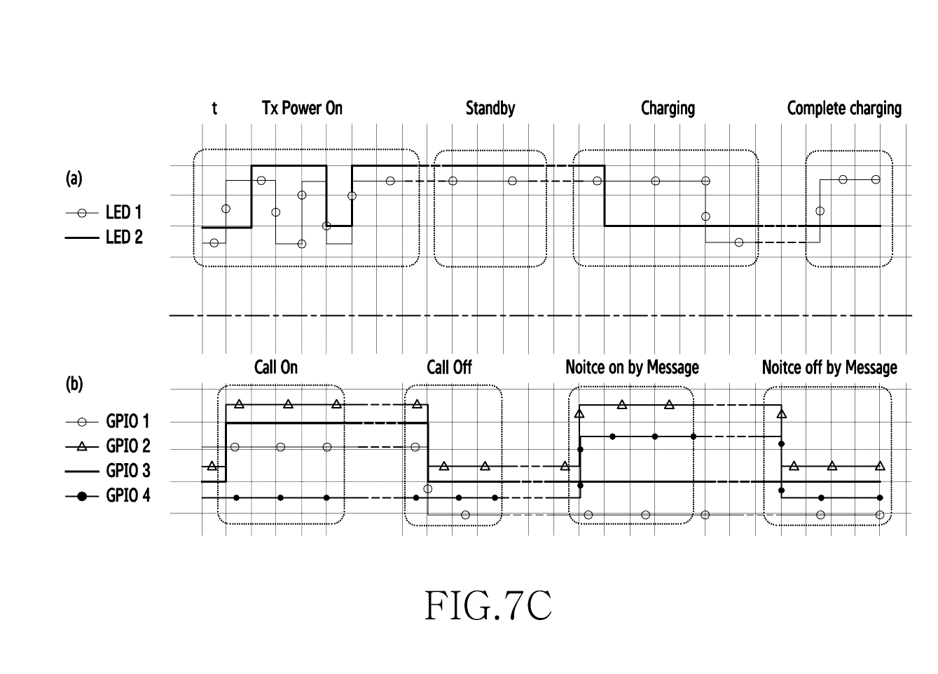

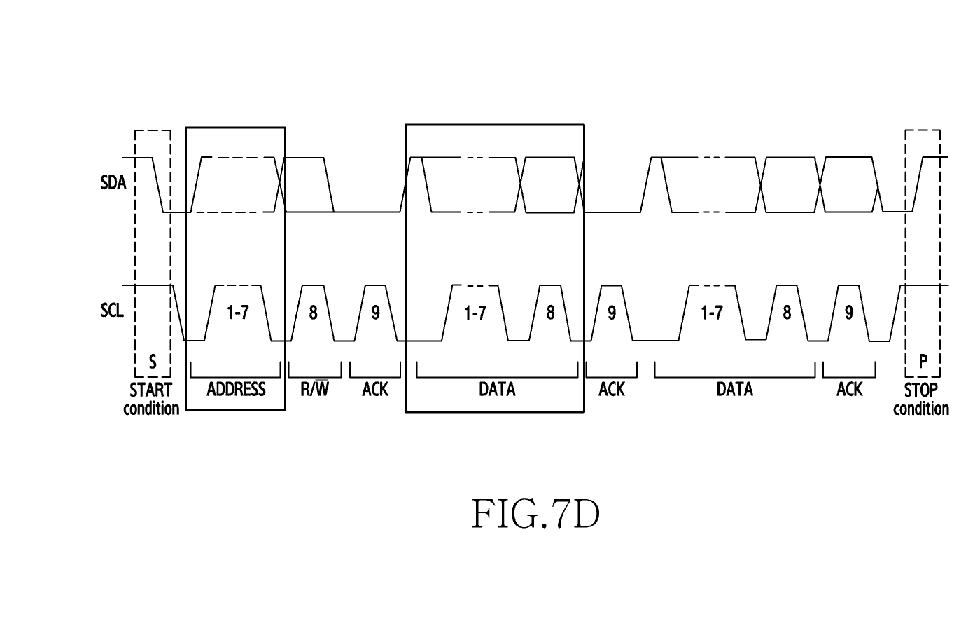

FIG. 6 illustrates a signal flow in a wireless charging system according to an embodiment of the present disclosure. FIG. 7A, FIG. 7B, FIG. 7C and FIG. 7D are exemplary diagrams illustrating a signal flow in a wireless charging system according to an embodiment of the present disclosure.

Referring to FIG. 6, the wireless power reception device 410 and the wireless power transmission device 420 may detect each other in step 611. When the wireless power reception device 410 is disposed so as to correspond to the wireless power transmission device 420, the wireless power reception device 410 and the wireless power transmission device 420 may detect each other. In addition, the wireless power transmission device 420 may identify the receiving scheme of the wireless power reception device 410.

For example, the wireless power transmission device 420 may periodically transmit a detection signal. Accordingly, when the detection signal is received, the wireless power reception device 410 may detect the wireless power transmission device 420. The wireless power reception device 410 may transmit a response signal corresponding to the detection signal. When the response signal is received, the wireless power transmission device 420 may detect the wireless power reception device 410. The wireless power transmission device 420 may analyze the response signal and identify a receiving scheme of the wireless power reception device 410.

When the wireless power reception device 410 is detected in step 611, the wireless power transmission device 420 wirelessly transmits power in step 613. That is, the wireless power transmission device 420 transmits power to the wireless power reception device 410. The wireless power transmission device 420 may transmit power using a wireless power protocol. When the receiving scheme of the wireless power reception device 410 is consistent with the transmission scheme of the wireless power transmission device 420, the wireless power transmission device 420 may transmit power according to the transmission scheme. For example, the wireless power transmission device 420 may transmit power as illustrated in (a) of FIG. 7A. Accordingly, the wireless power reception device 410 may wirelessly receive power. That is, the wireless power reception device 410 may receive power from the wireless power transmission device 420. The wireless power reception device 410 may receive power using a wireless power protocol. The wireless power reception device 410 may receive power according to the reception scheme.

While power is transmitted in step 613, the wireless power transmission device 420 receives notification data in step 615. That is, while power is received, the wireless power reception device 410 may generate notification data. The wireless power transmission device 420 may receive notification data using a wireless power protocol. The notification data may include at least one of communication information or charging state information. For example, when a communication event is received from a wireless communication network while power is received, the wireless power reception device 410 may generate communication information corresponding to the communication event. A communication event may include at least one of a call and a message. For example, the message may include at least one of a short message, a multimedia message, an instant message, or a social network service message.

While power is received, the wireless power reception device 410 may periodically check the charging state and generate charging state information. In addition, the wireless power reception device 410 may transmit notification data to the wireless power transmission device 420. The wireless power reception device 410 may transmit the notification data using a wireless power protocol. For example, the wireless power reception device 410 may transmit the notification data as shown in (b) of FIG. 7A. Accordingly, the wireless power transmission device 420 may receive the notification data from the wireless power reception device 410.

In the wireless charging system 100, a wireless power protocol 710 for notification data exchange as shown in FIG. 7B may be defined. The wireless power protocol 710 may include a state protocol 711 for charging state information and a communication protocol 713 for communication information. The wireless power protocol 710 may be defined by a general purpose input/output (GPIO) scheme. That is, the wireless power reception device 410 may generate notification data according to the wireless power protocol 710 as shown in FIG. 7C and transmit the notification data to the wireless power transmission device 420. That is, the wireless power reception device 410 may generate charging state information according to the state protocol 711, as shown in (a) in FIG. 7C. Alternatively, the wireless power reception device 410 may generate communication information according to the communication protocol 713, as shown in (b) in FIG. 7C. Accordingly, when the notification data is received, the wireless power transmission device 420 may analyze the notification data according to the wireless power protocol 710 and identify the notification data.

In the wireless charging system 100, the wireless power protocol 710 for notification data exchange may be defined in various ways. For example, the wireless power protocol may be defined by an inter-integrated circuit (I2C) scheme. That is, the wireless power reception device 410 may generate notification data in the I2C scheme as shown in FIG. 7D and transmit the notification data to the wireless power transmission device 420.

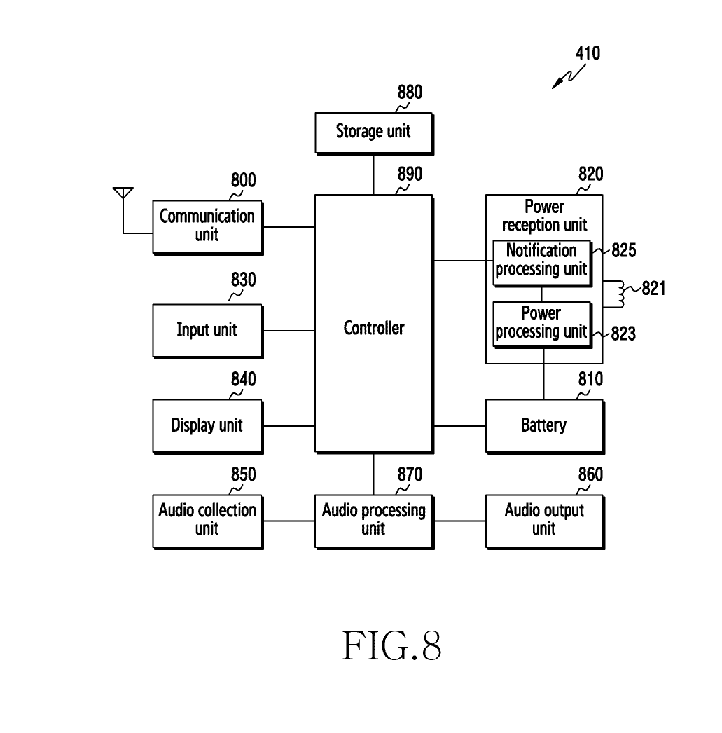

FIG. 8 is a block diagram of a wireless power reception device according to an embodiment of the present disclosure.

Referring to FIG. 8, the wireless power reception device 410 includes a communication unit 800, a battery 810, a power reception unit 820, an input unit 830, a display unit 840, an audio collection unit 850, the audio output unit 860, an audio processing unit 870, a storage unit 880, and a controller 890.

The communication unit 800 may perform communication in the wireless power reception device 410. The communication unit 800 may communicate with an external device in various communication schemes. The communication unit 800 may perform at least one of wireless communication or wired communication. The communication unit 800 may access at least one of a mobile communication network and a data communication network. Otherwise, the communication unit 800 may perform short-range communication. The communication unit 800 may include at least one wireless antenna. For example, the external device may include an electronic device, a base station, a server, and a satellite. In addition, the communication schemes may include long term evolution (LTE), wideband code division multiple Access (WCDMA), global system for mobile communications (GSM), Wi-Fi, Bluetooth, and near field communications (NFC).

The battery 810 may store power in the wireless power reception device 410. Here, the battery 810 may store DC power. The battery 810 may provide power for the operation of the wireless power reception device 410. To this end, the battery 810 may be repeatedly charged and discharged.

The power reception unit 820 may wirelessly receive power by the wireless power reception device 410. The power reception unit 820 may receive power according to a specified reception scheme. The reception scheme may include an electromagnetic induction scheme, a resonance scheme, and a RF scheme. In addition, the power reception unit 820 may perform a wireless interface with the wireless power transmission device 420. The power reception unit 820 may generate and wirelessly transmit notification data. The power reception unit 820 may include a power receiving antenna 821, a power processing unit 823, and a notification processing unit 825.

The power receiving antenna 821 may transmit and receive an electromagnetic wave. The power receiving antenna 821 may include at least one coil. The shape and the size of a coil may be determined corresponding to the reception scheme of the wireless power reception device 410.

The power processing unit 823 may receive power through the power receiving antenna 821. In addition, the power processing unit 823 may convert power. The power processing unit 823 may receive AC power and convert the AC power to DC power. The power processing unit 823 may include at least one of a rectifier circuit, a smoothing circuit, or a voltage control circuit. The rectifier circuit may convert AC power to DC power. The smoothing circuit may remove AC components from DC power. The voltage control circuit may control the voltage of DC power corresponding to the voltage of the battery 810. In addition, the power processing unit 823 may charge the battery 810 with power. That is, the power processing unit 823 may supply DC power to the battery 810.

The notification processing unit 825 may transmit notification data through the power receiving antenna 821. To this end, the notification processing unit 825 may generate notification data. The notification data may include at least one of communication information and charging state information. The notification processing unit 825 may generate communication information corresponding to a communication event. The communication event may include at least one of a call and a message. For example, the message may include at least one of a short message, a multimedia message, an instant message, or a social network service message. In addition, when the communication event is received from a wireless communication network, the notification processing unit 825 may generate communication information. For example, the notification processing unit 825 may receive an identifier of the communication event. On the other hand, the notification processing unit 825 may periodically check the charging state of the battery 810 and generate charging state information.

The input unit 830 may generate input data from the wireless power reception device 410. The input unit 830 may generate an input data, in response to an input by a user of the wireless power reception device 410. Further, the input unit 830 may include at least one input means. The input unit 830 may include a key pad, a dome switch, a physical button, a touch panel, a jog & shuttle, and a sensor.

The display unit 840 may output display data from the wireless power reception device 410. The display unit 840 may include an LCD, an LED display, an OLED display, a MEMS display, and an electronic paper display. Here, the display unit 840 may be implemented as a touch screen while being coupled to the input unit 830.

The audio collection unit 850 may collect audio signals. The audio collection unit 850 may detect audio signals from sound waves generated from the surrounding sound. Here, the audio collection unit 850 may detect analog audio signals. For example, the audio collection unit 850 may include a microphone (MIC).

The audio output unit 860 may output audio signals as sound waves and reproduce the sound. For example, the audio output unit 860 may output analog audio signals through a speaker (SPK).

The audio processing unit 870 may process the audio signals by the wireless power reception device 410. The audio processing unit 870 may receive the audio signals from the audio collection unit 850 and transfer the audio signals to the controller 890. Here, the audio processing unit 870 may convert the analog audio signals into digital audio signals. In addition, the audio processing unit 870 may receive the audio signals from the controller 890 and transfer the audio signals to the audio output unit 860. The audio processing unit 870 may convert the digital audio signals into the analog audio signals.

The storage unit 880 may store operation programs of the wireless power reception device 410. The storage unit 880 may store programs for transmitting notification data using the power reception unit 820. Further, the storage unit 880 may store data generated while the programs are executed.

The controller 890 may control the overall operation in the wireless power reception device 410. The controller 890 may perform various functions. To this end, the controller 890 may control components of the wireless power reception device 410. In addition, the controller 890 may receive and process commands or data from the components of the wireless power reception device 410.

In addition, the controller 890 may detect a communication event. The communication event may include at least one of a call and a message. For example, the message may include at least one of a short message, a multimedia message, an instant message or a social network service message. That is, when the communication event is received from a wireless communication network, the controller 890 may detect the communication event.

The controller 890 may transfer the communication event to the notification processing unit 825 of the power reception unit 820. For example, the controller 890 may identify the communication event and determine an identifier of the communication event. In addition, the controller 890 may transfer the identifier of the communication event to the notification processing unit 825. The controller 890 may transfer display data to the display unit 840. The controller 890 may transfer audio signals to the audio processing unit 870.

The wireless power reception device 410 may include the antenna 821 for wirelessly receiving power, the wireless communication unit 800, and the power reception unit 820 for functionally connected to the antenna 821 and wireless communication unit 800.

The power reception unit 820 may be coupled to the antenna 821 and include the notification processing unit 825 for transmitting a communication event received from the wireless communication unit 800 using the antenna 821.

The notification processing unit 825 may transmit the communication event using a wireless power protocol.

The notification processing unit 825 may generate notification data corresponding to a communication event and transmit the notification data using the antenna 821.

The notification processing unit 825 may modulate and encode the waveform of the received power and generate notification data.

The notification processing unit 825 may generate charging state information based on the received power and transmit the charging state information using the antenna 821.

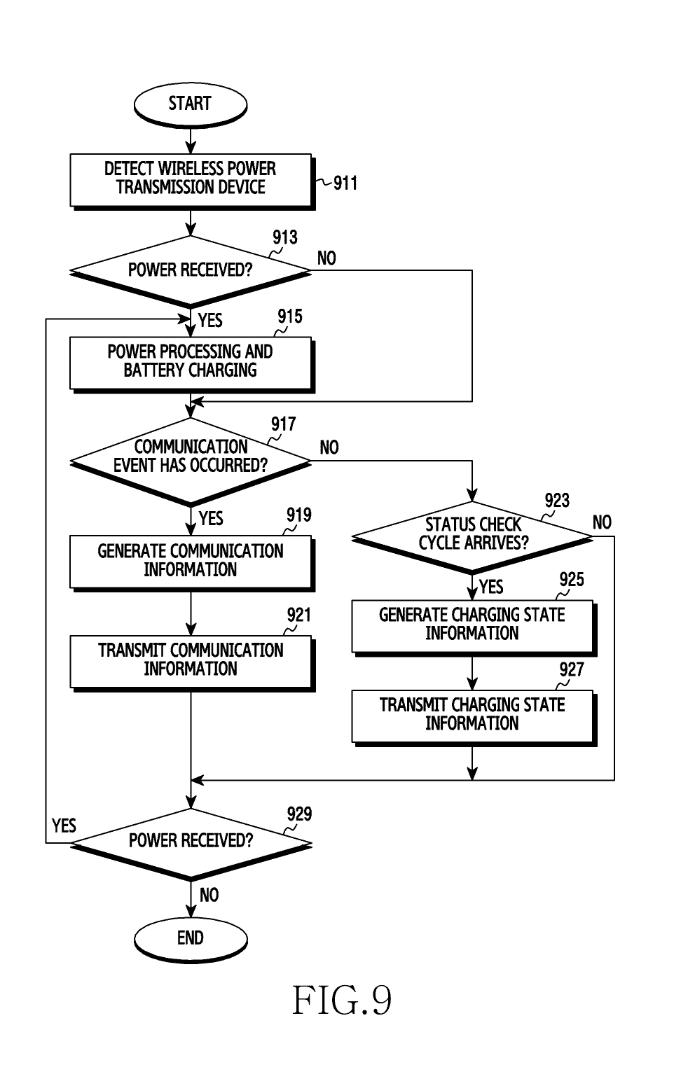

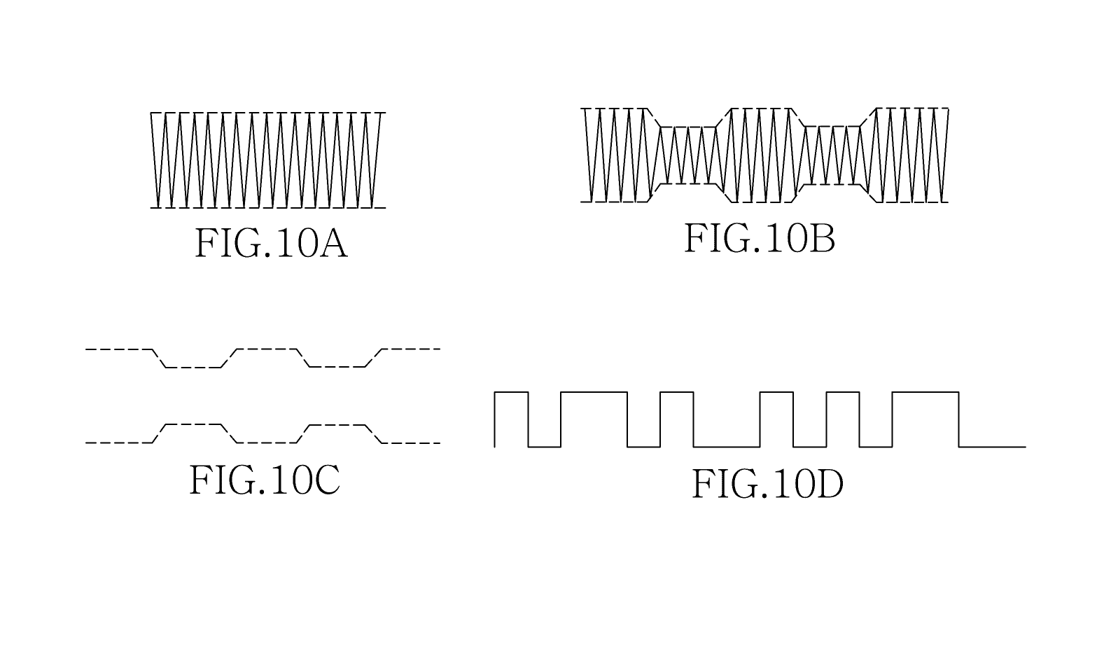

FIG. 9 shows a flow chart of an operating method of a wireless power reception device according to an embodiment of the present disclosure. FIG. 10A, FIG. 10B, FIG. 10C, and FIG. 10D are exemplary diagrams illustrating an operating method of a wireless power reception device 410 according to an embodiment of the present disclosure.

Referring to FIG. 9, the wireless power reception device 410 detects the wireless power transmission device 420 in step 911. The wireless power reception device 410 may be disposed to correspond to the wireless power transmission device 420. When the detection signal is received through the power receiving antenna 821, the power reception unit 820 may detect the wireless power transmission device 420. In addition, the power reception unit 820 may transmit a response signal through the power receiving antenna 821 in response to the detection signal.

When power is received, the wireless power reception device 410 (e.g., the power reception unit 820) may sense power in step 913. The power reception unit 820 senses the power when the power is received, in step 913. Here, the power reception unit 820 may receive the power through the power receiving antenna 821. In addition, the wireless power reception device 410 (e.g., the power reception unit 820) processes the power and charges the battery 810 in step 915. Here, the power processing unit 823 may receive power from the power receiving antenna 821. In addition, the power processing unit 823 may convert the power. Here, the power processing unit 823 may receive AC power and convert the AC power to DC power. In addition, the power processing unit 823 may supply DC power to the battery 810.

When the communication event occurs, the wireless power reception device 410 (e.g., the power reception unit 820) senses the communication event in step 917. When the communication event is received through the communication unit 800, the controller 890 may detect the communication event.

The communication event may include at least one of a call and a message. For example, the message may include at least one of a short message, a multimedia message, an instant message, or a social network service message.

In addition, the controller 890 may transfer the communication event to the notification processing unit 825 of the power reception unit 820. For example, the controller 890 may identify the communication event and determine the identifier of the communication event. Further, the controller 890 may transfer the identifier of the communication event to the notification processing unit 825. Accordingly, when the communication event is received from the controller 890, the notification processing unit 825 may sense the communication event. For example, the notification processing unit 825 may receive an identifier of the communication event.

In addition, the wireless power reception device 410 generates communication information in step 919. That is, the power reception unit 820 generates the communication information corresponding to the communication event. Thereafter, the wireless power reception device 410 transmits the communication information in step 921. Here, the power reception unit 820 transmits the communication information through the power receiving antenna 821.

When the communication event is not sensed and a cycle of a status check arrives in step 917, the wireless power reception device 410 senses the cycle of a status check in step 923. In addition, the wireless power reception device 410 generates charging state information in step 925. Here, the power reception unit 820 determines the charging state of the battery 810. In addition, the power reception unit 820 generates charging state information corresponding to the charging state of the battery 810. Thereafter, the wireless power reception device 410 transmits the charging state information in step 927. Here, the power reception unit 820 transmits the charging state information through the power receiving antenna 821.

Here, the wireless power reception device 410 may generate communication information or charging state information based on the power received through the power receiving antenna 821. For example, the power reception unit 820 may detect a charging current from the power received through the power receiving antenna 821, as shown in FIG. 10A. In addition, the power reception unit 820 may modulate the waveform of the charging current, as shown in FIG. 10B. In addition, the power reception unit 820 may detect the waveform as shown in FIG. 10C. Thereafter, the power reception unit 920 may encode the waveform corresponding to the communication information or charging state information as shown in FIG. 10D. According to various embodiments of the present disclosure, the power reception unit 820 may adjust the pulse width of the waveform corresponding to the communication information or charging state information.

When power is received, the wireless power reception device 410 senses the power in step 929. Here, the power reception unit 820 receives power through the power receiving antenna 821. In addition, the wireless power reception device 410 returns to step 915. Accordingly, the wireless power reception device 410 repeatedly performs at least one among step 915 to step 929. Thereafter, if power is not received in step 929, the wireless power reception device 410 terminates the operating method of the wireless power reception device 410.

If a communication event is sensed, the wireless power reception device 410 may wait until the cycle of a status check arrives. When the cycle of a status check has arrived, the wireless power reception device 410 may generate communication information and charging state information. In addition, the wireless power reception device 410 may generate and transmit notification data from the communication information and charging state information. On the other hand, the wireless power reception device 410 (may generate communication information according to an information generation cycle different from the cycle of a status check. In other words, even if a communication event is sensed, the wireless power reception device 410 may wait until the information generation cycle arrives. In addition, when the information generation cycle has arrived, the wireless power reception device 410 may generate and transmit the communication information. However, when the communication event is sensed, the wireless power reception device 410 generates communication information, and when the information generation cycle has arrived, the wireless power reception device 410 may transmit the communication information.

The operating method of the wireless power reception device 410 may include the steps of wirelessly receiving power from the antenna 821, detecting a communication event received from a wireless communication network, and transmitting notification data corresponding to the communication event using the antenna 821.

The transmitting operation may transmit the notification data using a wireless power protocol.

The transmitting operation may include an operation of generating the notification data.

The generating operation may generate the notification data by modulating and encoding the waveform of the received power.

An operating method of the wireless power reception device 410 may further include the operations of, generating charging state information based on the received power, and transmitting of the charging state information using the antenna 821.

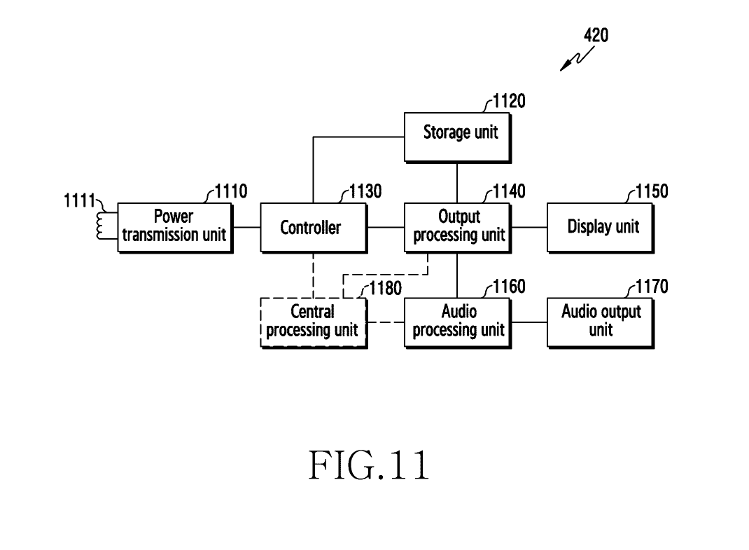

FIG. 11 is a block diagram of a wireless power transmission device according to an embodiment of the present disclosure.

Referring to FIG. 11, the wireless power transmission device 420 includes a power transmission unit 1110, a storage unit 1120, a controller 1130, an output processing unit 1140, a display unit 1150, an audio processing unit 1160, and an audio output unit 1170. The output processing unit 1140, the display unit 1150, the audio processing unit 1160, and the audio output unit 1170 may be implemented in a single output module 1140, 1150, 1160, and 1170.

The power transmission unit 1110 may wirelessly transmit power from the wireless power transmission device 420. The power transmission unit 1110 may transmit power according to a specified transmission scheme. The transmission scheme may include an electromagnetic induction scheme, a resonance scheme, and a RF scheme. In addition, the power transmission unit 1110 may perform a wireless interface with the wireless power reception device 410. The power transmission unit 1110 may receive notification data.

The power transmission unit 1110 includes a power transmission antenna 1111. The power transmission antenna 1111 may transmit and receive an electromagnetic wave. Here, the power transmission antenna 1111 may include at least one coil. The shape and size of the coil may be determined corresponding to the transmission scheme of the wireless power transmission device 420. That is, the power transmission unit 1110 may transmit power through the power transmission antenna 1111. In addition, the power transmission unit 1110 may receive the notification data through the power transmission antenna 1111. In addition, the power transmission unit 1110 may transfer the notification data to the controller 1130.

Specifically, the power transmission unit 1110 may receive DC power from the power source 430. In addition, the power transmission unit 1110 may further include at least one of an oscillation circuit and a power conversion circuit. The oscillation circuit may generate an AC signal. The oscillation circuit may generate an AC signal corresponding to the transmission scheme of the wireless power transmission device 420. For example, the oscillation circuit may generate an AC signal so as to have a specified frequency. The power conversion circuit may generate AC power using DC power and an AC signal. Here, the power conversion circuit may amplify the AC signal. In addition, the power conversion circuit may output the AC power to the power transmission antenna 1111. For example, a power conversion circuit may have a structure of a push-pull type. The structure of a push-pull type may represent a structure in which a pair of switches, transistors, or any circuit blocks alternately operate and alternately output a response.

The storage unit 1120 may store operation programs of the wireless power transmission device 420. The storage unit 1120 may store programs for receiving notification data using the power transmission unit 1110. In addition, the storage unit 1120 may store programs for outputting alarm information corresponding to the notification data. In addition, the storage unit 1120 may store data generated while executing the programs. In addition, the storage unit 1120 may store the alarm information corresponding to the notification data.

The controller 1130 may control an overall operation in the wireless power transmission device 420. The controller 1130 may perform various functions. To this end, the controller 1130 may control elements of the wireless power transmission device 420. The controller 1130 may control a power source in the wireless power transmission device 420. The controller 1130 may turn on or off the elements of the wireless power transmission device 420. The controller 1130 may receive and process commands or data from the elements of the wireless power transmission device 420.

In addition, the controller 1130 may detect the notification data. That is, if the notification data is received from the power transmission unit 1110, the controller 1130 may detect the notification data. In addition, the controller 1130 may analyze the notification data. For example, the controller 1130 may decode the notification data. Accordingly, the controller 1130 may identify the notification data. For example, if the notification data includes communication information, the controller 1130 may identify a communication event corresponding to the communication information and determine an identifier of the communication event. The communication event may include at least one of a call and a message. For example, the message may include at least one of a short message, a multimedia message, an instant message, or a social network service message. If the notification data includes charging state information, the controller 1130 may identify a charging state corresponding to the charging state information. The controller 1130 may transfer the alarm information corresponding to the notification data to the output module 1140, 1150, 1160, and 1170. If the output module 1140, 1150, 1160, and 1170 is off, the controller 1130 may supply a standby power to the output module 1140, 1150, 1160, and 1170.

The output processing unit 1140 may process the alarm information in the wireless power transmission device 420. The output processing unit 1140 may determine at least one of display data and an audio signal corresponding to the alarm information. In addition, the output processing unit 1140 may control the display unit 1150 and the audio processing unit 1160. The output processing unit 1140 may transfer the display data to the display unit 1150. In addition, the output processing unit 1140 may transfer the audio signal to the audio processing unit 1160.

The display unit 1150 may output the display data in the wireless power transmission device 420. The display unit 1150 may include an LCD, an LED display, an OLED display, a MEMS display, and an electronic paper display.

The audio processing unit 1160 may process the audio signal in the wireless power transmission device 420. The audio processing unit 1160 may receive an audio signal from the output processing unit 1140 and transfer the audio signal to the audio output unit 1170. Here, the audio processing unit 1170 may convert a digital audio signal into an analog audio signal.

The audio output unit 1170 may output the audio signal. The audio output unit 1170 may output the audio signal as sound waves so as to reproduce the sound. Here, the audio output unit 1170 may output the analog audio signal. For example, the audio output unit 1170 may include a speaker (SPK).

The wireless power transmission device 420 may further include a central processing unit 1180. The central processing unit 1180 may execute various applications. For example, the central processing unit 1180 may be an AP. In addition, the central processing unit 1180 may be connected to the controller 1130. Accordingly, the central processing unit 1180 may be turned on or off by the controller 1130. In addition, the central processing unit 1180 may further be connected to at least one of the output processing unit 1140 or the audio processing unit 1160. For example, the central processing unit 1180 may further be connected to at least one of the output processing unit 1140 and the audio processing unit 1160, separately from the controller 1130. In addition, the central processing unit 1180 may control at least one of the output processing unit 1140 or the audio processing unit 1160, separately from the controller 1130.

The controller 1130 may operate independently of the on and off of the central processing unit 1180. That is, the controller 1130 may control the output module 1140, 1150, 1160, and 1170 and output the alarm information corresponding to the notification data. If the central processing unit 1180 is tuned off (deactivated state), the controller 1130 may supply standby power to the output module 1140, 1150, 1160, and 1170 and transfer the alarm information to the same. Accordingly, the output module 1140, 1150, 1160, and 1170 may operate by the standby power supplied from the controller 1130. On the other hand, if the central processing unit 1180 is turned on (active state), the central processing unit 1180 may supply the drive power to the output module 1140, 1150, 1160, and 1170, and the controller 1130 may transfer the alarm information to the output module 1140, 1150, 1160, and 1170. Accordingly, the output module 1140, 1150, 1160, and 1170 may operate by the drive power supplied from the central processing unit 1180.

The wireless power transmission device 420 include the power transmission unit 1110 including the antenna 1111 for wirelessly transmitting power, the controller 1130 for detecting a communication event received from the antenna 1111 and identifying the communication event, and the output module 1140, 1150, 1160, and 1170 for outputting the alarm information corresponding to the communication event.

The controller 1130 may receive the communication event using a wireless power protocol.

The controller 1130 may supply standby power to the output module 1140, 1150, 1160, and 1170 when the output module 1140, 1150, 1160, and 1170 is turned off.

The output module 1140, 1150, 1160, and 1170 may include the output processing unit 1140 for determining display data corresponding to the alarm information, and the display unit 1150 for displaying the display data.

The output module 1140, 1150, 1160, and 1170 may include the output processing unit 1140 for determining an audio signal corresponding to the alarm information, and the audio output unit 1170 for outputting the audio signal.

The controller 1130 may detect the charging state information received from the antenna 1111 and identify a charging state from the charging state information.

The output module 1140, 1150, 1160, and 1170 may output alarm information corresponding to the charging state.

The power transmission unit 1110 may detect the charging state information received from the antenna 1111 and control power to be transmitted based on the charging state information.

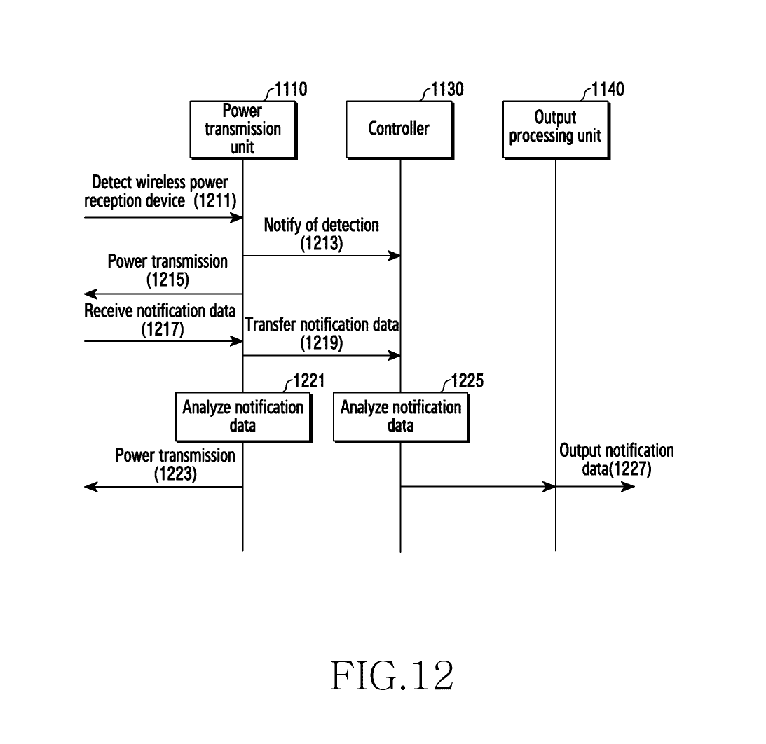

FIG. 12 shows a signal flow in a wireless power transmission device according to an embodiment of the present disclosure.

Referring to FIG. 12, in the wireless power transmission device 420, the power transmission unit 1110 detects the wireless power reception device 410 in step 1211. The wireless power reception device 410 may be disposed to correspond to the wireless power transmission device 420. Accordingly, when a response signal is received, the power transmission unit 1110 may detect the wireless power reception device 410.

In step 1213, the power transmission unit 1110 notifies the detection of the wireless power reception device 410 to the controller 1130.

In step 1215, the power transmission unit 1110 wirelessly transmits power in. That is, the power transmission unit 1110 transmits the power to the wireless power reception device 410.

While transmitting power in step 1215, the power transmission unit 1110 receives notification data in step 1217. That is, the power transmission unit 1110 receives the notification data from the wireless power reception device 410. According to various embodiments of the present disclosure, the notification data may include at least one of the communication information and charging state information.

In step 1219, the power transmission unit 1110 transfers the notification data to the controller 1130.

The power transmission unit 1110 analyzes the notification data in step 1221. The power transmission unit 1110 may detect the charging state information from the notification data. In addition, the power transmission unit 1110 may figure out the charging state of the wireless power reception device 410 based on the charging state information.

In step 1223, the power transmission unit 1110 may transmit power. That is, the power transmission unit 1110 may transmit the power to the wireless power reception device 410. The power transmission unit 1110 may control the power based on the charging state of the wireless power reception device 410.

When the notification data is received in step 1219, the controller 1130 analyzes the notification data in step 1225. Accordingly, the controller 1130 may identify the notification data. The controller 1130 may detect at least one of the communication information and the charging state information from the notification data. In addition, the controller 1130 may identify a communication event corresponding to the communication information.

The communication event may include at least one of a call and a message. For example, the message may include at least one of a short message, a multimedia message, an instant message, or a social network service message. In addition, the controller 1130 may identify the charging state of the wireless power reception device 410 based on the charging state information.

In step 1227, the controller 1130 outputs the notification data through the output processing unit 1140. The controller 1130 may output alarm information corresponding to the notification data. The output processing unit 1140 may output at least one of display data and an audio signal corresponding to the alarm information.

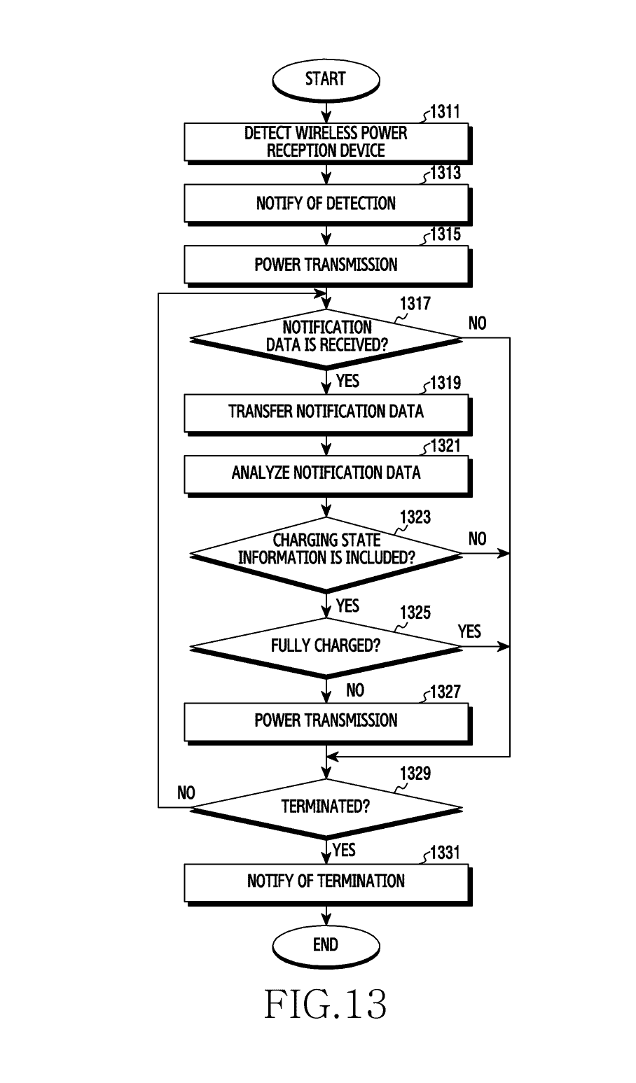

FIG. 13 shows a flow chart of an operating method of a wireless power transmission device 420 according to an embodiment of the present disclosure.

Referring to FIG. 13, the wireless power transmission device 420 starts by detecting the wireless power reception device 410 in step 1311. The wireless power reception device 410 may be disposed to correspond to the wireless power transmission device 420. Accordingly, when a response signal is received through the power transmission antenna 1111, the power transmission unit 1110 may detect the wireless power reception device 410. Here, the power transmission unit 1110 may analyze the response signal so as to identify the receiving scheme of the wireless power reception device 410.

In step 1313, the wireless power transmission device 420 notifies the detection of the wireless power reception device 410 to the controller 1130.

In step 1315, the wireless power transmission device 420 wirelessly transmits power. That is, the power transmission unit 1110 transmits the power to the wireless power reception device 410. Here, when the receiving scheme of the wireless power reception device 410 is consistent with the transmission scheme of the wireless power transmission device 420, the power transmission unit 1110 may transmit the power. The power transmission unit 1110 may transmit the power through the power transmission antenna 1111.

When notification data is received while transmitting power, the wireless power transmission device 420 senses the notification data in step 1317. That is, the power transmission unit 1110 receives the notification data from the wireless power reception device 410. The power transmission unit 1110 may receive the notification data through the power transmission antenna 1111. Here, the notification data may include at least one of the communication information and the charging state information. In addition, the wireless power transmission device 420 transfers the notification data to the controller 1130 in step 1319.

The wireless power transmission device 420 analyzes the notification data in step 1321. For example, the power transmission unit 1110 may decode the notification data. The power transmission unit 1110 may detect charging state information in the notification data. In addition, the wireless power transmission device 420 determines whether the notification data includes the charging state information in step 1323.

When it is determined that the notification data includes the charging state information in step 1323, the wireless power transmission device 420 determines whether the wireless power reception device 410 is in a fully charged state based on the charging state information, in step 1325. That is, the power transmission unit 1110 may figure out the charging state of the wireless power reception device 410 based on the charging state information. Accordingly, the power transmission unit 1110 may determine whether the wireless power reception device 410 is in a fully charged state.

When it is determined that the wireless power reception device 410 is not in a fully charged state in step 1325, the wireless power transmission device 420 wirelessly transmits power in step 1327. That is, the power transmission unit 1110 transmits the power to the wireless power reception device 410. The power transmission unit 1110 may transmit the power through the power transmission antenna 1111.

When a termination event occurs, the wireless power transmission device 420 senses the occurrence of the event in step 1329. When a detachment of the wireless power reception device 410 is detected, the power transmitting unit 1110 may detect the same as the termination event. For example, when the cycle of a status check has arrived and the notification data is not received from the wireless power reception device 410, the power transmission unit 1110 may detect the detachment of the wireless power reception device 410. However, when the connection is released from the power source 430, the power transmission unit 1110 may detect the same as the termination event. That is, when power is not supplied from the power source 430, the power transmission unit 1110 may detect the connection release from the power source 430. In addition, the wireless power transmission device 420 notifies the termination to the controller 1130 in step 1331. Thereafter, the power transmission unit 1110 may terminate the operating method of the wireless power transmission device 420.

When the termination event is not detected in step 1329, the wireless power transmission device 420 returns to step 1317. In addition, the wireless power transmission device 420 repeats at least one step among steps 1317 to step 1329.

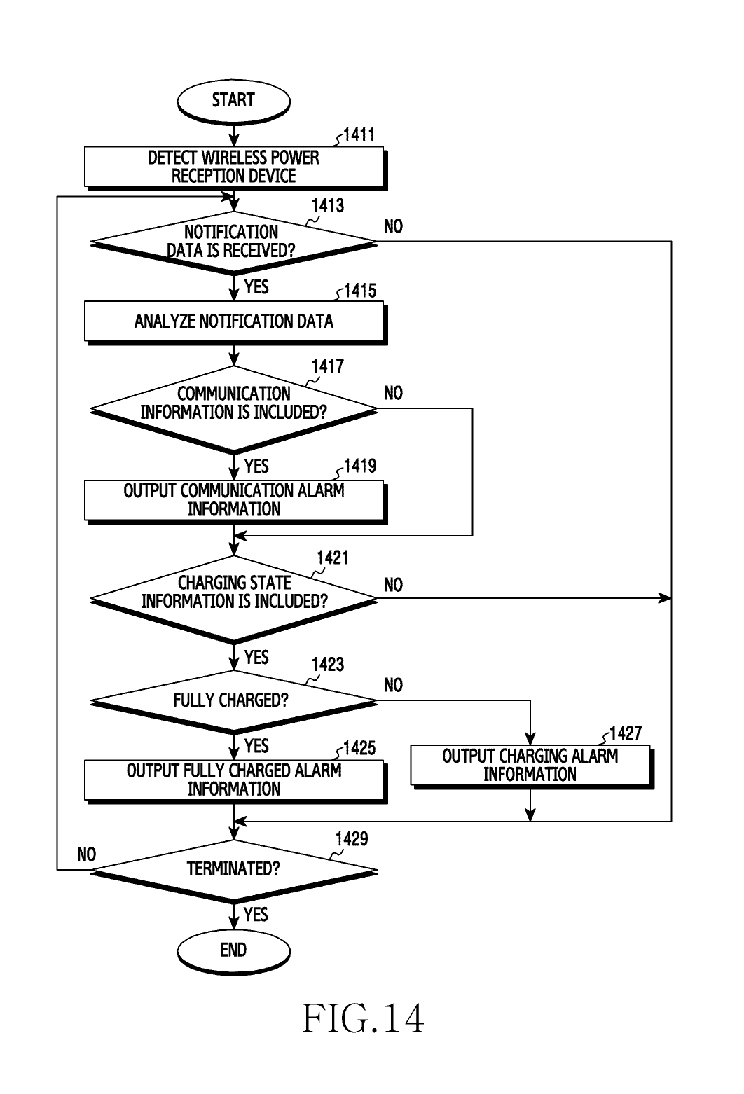

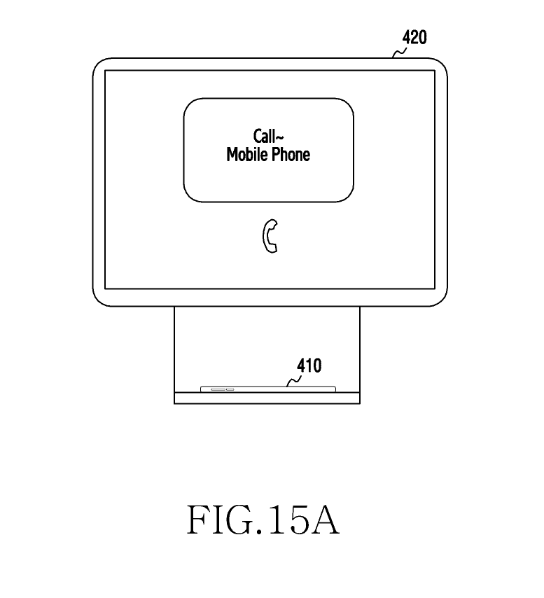

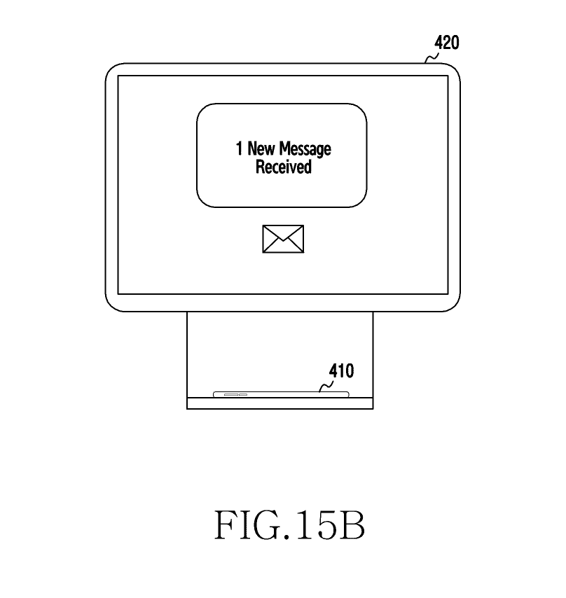

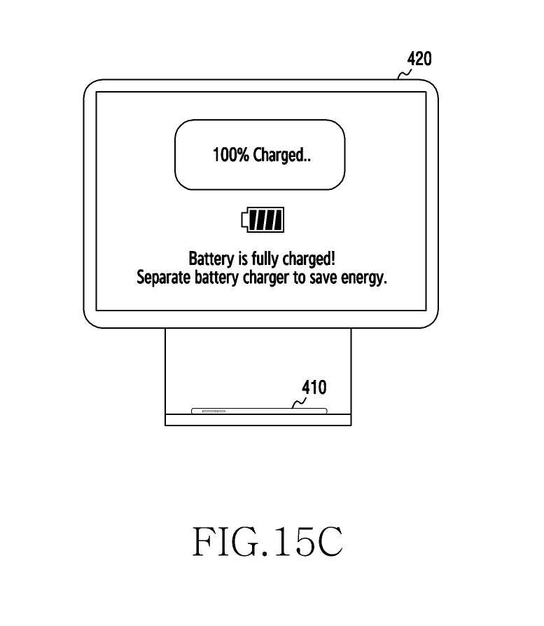

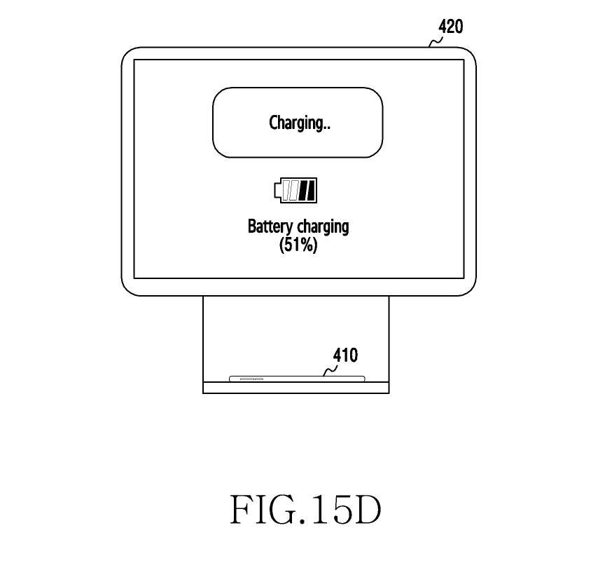

FIG. 14 shows a flow chart of an operating method of a wireless power transmission device according to an embodiment of the present disclosure. FIG. 15A, FIG. 15B, FIG. 15C, and FIG. 15D are diagrams illustrating the operating method of a wireless power transmission device according to an embodiment of the present disclosure.

Referring to FIG. 14, the wireless power transmission device 420 starts by detecting the wireless power reception device 410 in step 1411. That is, when the power transmission unit 1110 notifies of the detection of the wireless power reception device 410, the controller 1130 may sense the same. When the output module 1140, 1150, 1160, and 1170 is turned off, the controller 1130 may supply standby power to the output module 1140, 1150, 1160, and 1170. Accordingly, when the output module 1140, 1150, 1160, and 1170 is turned on, the output module 1140, 1150, 1160, and 1170 may operate by the drive power. On the other hand, when the output module 1140, 1150, 1160, and 1170 are turned off, the output module 1140, 1150, 1160, and 1170 may operate by the standby power.

When the notification data is received, the wireless power transmission device 420 (e.g., the controller 1130) detects the same in step 1413. That is, the controller 1130 may receive the notification data from the power transmission unit 1110. In addition, the wireless power transmission device 420 (e.g., the controller 1130) analyzes the notification data in step 1415. For example, the controller 1130 may decode the notification data. Accordingly, the controller 1130 may identify the notification data. The controller 1130 may detect at least one of communication information and charging state information in the notification data. In addition, the controller 1130 may identify a communication event corresponding to the communication information. The communication event may include at least one of a call and a message. For example, the message may include at least one of a short message, a multimedia message, an instant message, or a social network service message. In addition, the controller 1130 may identify the charging state of the wireless power reception device 410 based on the charging state information.

The wireless power transmission device 420 (e.g., the controller 1130) may determine whether the notification data includes the communication information in step 1417. When it is determined that the notification data includes the communication information in step 1417, the wireless power transmission device 420 outputs communication alarm information in step 1419. Here, the communication alarm information may indicate the alarm information corresponding to the communication event. That is, the controller 1130 may output the communication alarm information through the output processing unit 1140. Here, the controller 1130 may transfer the communication alarm information to the output processing unit 1140.

Accordingly, the wireless power transmission device 420 may determine at least one of display data and an audio signal, corresponding to the communication alarm information. The output processing unit 1140 may display the display data through the display 1150 or reproduce the audio signal through the audio processor 1160. For example, when the communication event is a call, the output processing unit 1140 may display the display data as shown in FIG. 15A. When the communication event is a message, the output processing unit 1140 may display the display data as shown in FIG. 15B.

The wireless power transmission device 420 (e.g., the controller 1130) determines whether the notification data includes charging state information in step 1421. When it is determined that the notification data includes the charging state information in step 1421, the wireless power transmission device 420 (e.g., the controller 1130) determines whether the wireless power reception device 410 is in a fully charged state in step 1423. That is, the controller 1130 may determine whether the charging state of the wireless power reception device 410 is fully charged. When it is determined that the wireless power reception device 410 is in a fully charged state in step 1423, the wireless power transmission device 420 outputs full charging alarm information in step 1425. The controller 1130 may transfer the full charge alarm information to the output processing unit 1140.

When it is determined that the wireless power reception device 410 is not in a fully charged state in step 1423, the wireless power transmission device 420 (e.g., the controller 1130) may output charge alarm information in step 1427. Here, the controller 1130 may transfer the charge alarm information to the output processing unit 1140.

Accordingly, the wireless power transmission device 420 may determine at least one of display data and an audio signal, corresponding to the full charging alarm information or charge alarm information. The output processing unit 1140 may display the display data through the display 1150 or reproduce the audio signal through the audio processing unit 1160. For example, when the wireless power reception device 410 is in a fully charged state, the output processing unit 1140 may display the display data as shown in FIG. 15C. On the other hand, when the wireless power reception device 410 is not in a fully charged state, the output processing unit 1140 may display the display data as shown in FIG. 15D.

Finally, when a termination event occurs, the wireless power transmission device 420 (e.g., the controller 1130) detects the occurrence of the event in step 1429. When the power transmission unit 1110 notifies of the termination, the controller 1130 may detect the same as a termination event. Thereafter, the controller 1130 may terminate an operating method of the wireless power transmission device 420.

When the termination event is not detected in step 1429, the wireless power transmission device 420 returns to step 1413. In addition, the wireless power transmission device 420 may repeatedly perform at least one step among step 1413 to step 1429.

The operating method of the wireless power transmission device 420 may include the operations of wirelessly transmitting power using the antenna 1111, detecting a communication event received from the antenna 1111, identifying the communication event, and outputting alarm information corresponding to the communication event.

The detecting of the communication event may include receiving of a communication event using a wireless power protocol.

The outputting of the alarm information may include an operation of, when the output module 1140, 1150, 1160, and 1170 is turned off, supplying standby power to the output module 1140, 1150, 1160, and 1170 and outputting the alarm information by the output module 1140, 1150, 1160, and 1170.

The outputting of the alarm information may include an operation of determining of display data corresponding to the alarm information and displaying the display data.

The outputting of the alarm information may include an operation of determining of an audio signal corresponding to the alarm information and outputting the audio signal.

An operating method of the wireless power transmission device 420 may further include the operations of detecting charging state information received from the antenna 1111, identifying a charging state from the charging state information, and outputting the alarm information corresponding to the charging state.

The transmitting of the power may include the operations of detecting of the charging state information received from the antenna 1111, and controlling the power to be transmitted based on the charging state information.

The wireless power reception device 410 may transmit the communication event through the antenna 821 for wirelessly receiving power. Accordingly, the wireless power transmission device 420 may receive and output the communication event through the antenna 1111 for wirelessly transmitting power. Accordingly, when the wireless power reception device 410 is being charged, the user of the wireless power reception device 410 may recognize the communication event through the wireless power transmission device 420. That is, even if the wireless power reception device 410 is not being carried, the user of the wireless power reception device 410 may recognize the communication event through the wireless power transmission device 420.

The wireless power reception device 410 may transmit a charging state of the wireless power reception device 410 through the antenna 821 for wirelessly receiving power. Accordingly, the wireless power transmission device 420 may receive and output the charging state of the wireless power reception device 410 through the antenna 1111 for wirelessly transmitting power. Accordingly, when the wireless power reception device 410 is being charged, the user of the wireless power reception device 410 may recognize the charging state of the wireless power reception device 410 through the wireless power transmission device 420. That is, even when a user of the wireless power reception device 410 is located at a distance from the wireless power reception device 410, the user may recognize the charging state of the wireless power reception 410.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. An electronic device comprising:
an antenna configured to wirelessly receive power;
a wireless communication unit; and
a power reception unit functionally connected to the antenna and wireless communication unit,
wherein the power reception unit includes a notification processing unit, the notification processing unit being configured to transmit, via the antenna, to an external device, a communication event received from the wireless communication unit during wireless charging.

2. The electronic device of claim 1, wherein the notification processing unit is further configured to transmit the communication event using a wireless power protocol.

3. The electronic device of claim 1, wherein the notification processing unit is further configured to generate notification data corresponding to the communication event and transmit the notification data using the antenna.

4. The electronic device of claim 3, wherein the notification processing unit is further configured to generate the notification data by modulating and encoding a waveform of received power.

5. A method of an electronic device, the method comprising:
wirelessly receiving power via an antenna;
detecting a communication event received from a wireless communication network; and
transmitting notification data corresponding to the communication event to an external device during wireless charging.

6. The method of claim 5, wherein transmitting the notification data comprises transmitting the notification data using a wireless power protocol.

7. The method of claim 5, further comprising generating the notification data.

8. The method of claim 7, wherein generating of the notification data comprises generating the notification data by modulating and encoding a waveform of the received power.

9. An electronic device comprising:
a power transmission unit configured to wirelessly transmit power to an external device;
a controller configured to detect a communication event received from the external device; and
an output module configured to output alarm information corresponding to the communication event.

10. The electronic device of claim 9, wherein the controller is further configured to receive the communication event using a wireless power protocol.

11. The electronic device of claim 9, wherein the controller is further configured to supply standby power to the output module, when the output module is turned off.

12. The electronic device of claim 9, wherein the output module comprises:
an output processing unit configured to determine display data corresponding to the alarm information; and
a display unit configured to display the display data.

13. The electronic device of claim 9, wherein the output module comprises:
an output processing unit configured to determine an audio signal corresponding to the alarm information; and
an audio output unit configured to output the audio signal.

14. The electronic device of claim 9, wherein the controller is further configured to detect charging state information received from the external device and identify a charging state of the external device from the charging state information, and
wherein the output module is further configured to output alarm information corresponding to the charging state.

15. A method of an electronic device, the method comprising:
wirelessly transmitting power to an external device;
detecting a communication event received from the external device; and
outputting alarm information corresponding to the detected communication event.

16. The method of claim 15, wherein detecting the communication event comprises receiving the communication event using a wireless power protocol.

17. The method of claim 15, wherein outputting the alarm information comprises:
when an output module is turned off, supplying standby power to the output module; and
outputting the alarm information by the output module.

18. The method of claim 15, wherein outputting the alarm information comprises:
determining display data corresponding to the alarm information; and
displaying the display data.

19. The method of claim 15, wherein outputting the alarm information comprises:
determining an audio signal corresponding to the alarm information; and
outputting the audio signal.

20. The method of claim 15, further comprising:
detecting charging state information received from the external device;
identifying a charging state of external device from the charging state information; and
outputting alarm information corresponding to the identified charging state.
